(19) United States
(12) Patent Application Publication
(10) Pub. No.: US 2016/0197363 A1
(43) Pub. Date: Jul. 7, 2016

(54) ION FILTER LIFETIME PERCEPTION DEVICE FOR FUEL CELL VEHICLE

(71) Applicants: Hyundai Motor Company, Seoul (KR); Kia Motors Corporation, Seoul (KR)

(72) Inventors: Sung Wook Na, Yongin (KR); Hun Woo Park, Namyangju (KR)

(21) Appl. No.: 14/680,588

(22) Filed: Apr. 7, 2015

(30) Foreign Application Priority Data
Jan. 5, 2015 (KR) 10-2015-0000852

(51) Int. Cl. H01M 8/04; B01J 47/14

(52) U.S. Cl. CPC H01M 8/04044; B01J 47/14; H01M 2250/20

(57) ABSTRACT

An ion filter lifetime perception device for a fuel cell vehicle is provided that detects a replacement lifetime of a cartridge of a fuel cell ion filter. The ion filter lifetime perception device includes a mesh tube body that is mounted in an ion filter and contains an ion resin filed therein. A checker is disposed at the mesh tube body to be movable toward a first end and a second end of the mesh tube body. The checker is exposed to the exterior of the mesh tube body and has a second end inserted into the mesh tube body. In addition, an elastic member is disposed between the second end of the checker and the first end of the mesh tube body to push the checker from the first end to the second end of the mesh tube body by elasticity.

### CROSS-REFERENCE TO RELATED APPLICATION

This application is based on and claims the benefit of priority to Korean Patent Application No. 10-2015-0000852, filed on Jan. 5, 2015 in the Korean Intellectual Property Office, the disclosure of which is incorporated herein in its entirety by reference.

### TECHNICAL FIELD

The present disclosure relates to an ion filter lifetime perception device for a fuel cell vehicle, and more particularly, to an ion filer lifetime perception device for a fuel cell vehicle that detects a replacement lifetime of a cartridge of a fuel cell ion filter.

### BACKGROUND

Recently, various eco-friendly electric vehicles capable of reducing energy consumption and environmental contamination have been developed, such as, fuel cell vehicles and hybrid vehicles. The fuel cell vehicle is a vehicle that uses electricity generated by electrochemical reactions of hydrogen and oxygen as an energy source. The hybrid vehicle is a vehicle that uses an internal combustion engine during high-speed driving or uphill-driving and uses electricity during low-speed driving or stopping a vehicle as an energy source.

In general, unlike an existing internal combustion engine vehicle that obtains driving force by explosively reacting fossil fuel with oxygen in the air within an engine to convert the chemical energy into mechanical energy, for the fuel cell vehicle, the vehicle is driven using electric energy generated by electrochemically reacting hydrogen supplied through a high-pressure hydrogen tank or a reformer with oxygen in the air supplied through an air turbo compressor in a fuel cell stack. In other words, a fuel cell system, which is a device that directly converts energy of fuel into electric energy, is a system in which a pair of electrodes composed of an anode and a cathode are disposed with an electrolyte interposed therebetween, and electricity and heat are obtained through an electrochemical reaction of an ionized fuel gas.

Since a polymer electrolyte fuel cell has advantages such as high current density, a low operation temperature, corrosion resistance, and a small loss in an electrolyte, the polymer electrolyte fuel cell has started to be developed as a power source for military uses or a spacecraft. However, currently, research for applying the polymer electrolyte fuel cell as a power source of a vehicle using the fact that the polymer electrolyte may be modulated due to a high power density has been actively conducted.

This fuel cell system is configured to include a fuel cell stack that generates electric energy from an electrochemical reaction of reaction gas, a hydrogen supply device that supplies hydrogen as a fuel to the fuel cell stack, an air supply device that supplies air including oxygen, which is an oxidant required in the electrochemical reaction, to the fuel cell stack, and a heat and water management system that discharges heat, which is a by-product of the electrochemical reaction of the fuel cell stack, to the exterior to adjust an operation temperature of the fuel cell stack and perform a water management function. In particular, the heat and water management system includes an ion filter which removes metal ions from coolant released from the fuel cell stack after circulating through the fuel cell stack to extend a lifetime of the fuel cell and stabilize the fuel cell system.

In other words, the ion filter of the fuel cell vehicle is positioned on a stack coolant loop to secure electric stability of the system through ion filtering to prevent electric shock by high power stack that corresponds to about 100 kW. For example, an ion resin is mounted in a cartridge to remove and manage electric conductivity increased by cations/anions existing in stack coolant at a predetermined level or less, such that the ion filter serves to improve insulation stability of the vehicle.

Therefore, a particulate form ion resin substantially filtering ions contained in the coolant is embedded in the ion filter. The coolant released after circulating through the fuel cell stack is introduced in the ion filter, metal ions are removed by the ion resin in the ion filter, and then, the coolant is circulated to the fuel cell stack again, to properly control a degree of ionization in the stack coolant, that is, electric conductivity.

Meanwhile, electric conductivity of the stack coolant is measured by an electric conductivity sensor, and when the electric conductivity measured by the electric conductivity sensor is a reference value or greater, electric conductivity in the stack coolant is managed to be a reference value or less by replacing the cartridge of the ion filter. For example, whether the cartridge of the ion filter requires replacement is determined by measuring electric conductivity by the electric conductivity sensor and periodically transferring electric conductivity signals of the coolant to a fuel control unit (FCU) via controller area network (CAN) communications.

However, in the electric conductivity sensing type as described above, since a volume of the electric conductivity sensor is substantial, and cost is expensive, there are disadvantageous in view of layout or an economical aspect. Further, when there are defects in the electric conductivity sensor or CAN communications, it may be difficult to determine a replacement time of the cartridge of the ion filter.

### SUMMARY

An aspect of the present disclosure provides an ion filter lifetime perception device for a fuel cell vehicle that may improve maintainability of a vehicle by determining a replacement lifetime of a cartridge of a fuel cell ion filter using the principle of volume reduction of an ion resin.

According to an exemplary embodiment of the present disclosure an ion filter lifetime perception device for a fuel cell vehicle may include: a mesh tube body mounted in an ion filter, containing an ion resin filed therein, and provided with fine apertures to penetrate coolant therethrough; a checker disposed at the mesh tube body to be movable toward one portion and the other portion and having one end (e.g., a first end) penetrating through one end of the mesh tube body to be exposed to the exterior and the other end (e.g., a second end) inserted into the mesh tube body; and an elastic member disposed between the other end of the checker and one end of the mesh tube body to push the checker from one portion to the other portion by elasticity.

The mesh tube body may further include an aperture formed at one end thereof to allow the checker to penetrate therethrough. The checker may further include a gauge member having a circumference greater than that of the aperture at one end thereof. The gauge member may be exposed to the exterior of a cartridge of the ion filter. The gauge member may be mounted in the ion filter to be covered by a transparent cover made of a transparent material, such that the gauge member may be identified from the exterior. The mesh tube body may be entirely or partially provided with a plurality of fine apertures.

The checker may further include a packing member formed at the other end thereof to allow an internal portion of a body part and a circumference of the checker to be air-tight. The other end (e.g., the second end) of the elastic member may be supported by the packing member and one end (e.g., the first end) of the elastic member may be supported by one end of the mesh tube body. The checker may move from one portion to the other portion as much as (e.g., relative to) a volume of the ion resin is reduced.

According to another exemplary embodiment of the present disclosure, ion filter lifetime perception device for a fuel cell vehicle, which may be installed within a fuel cell stack, may include: a mesh tube body mounted in an ion filter to be positioned on a coolant channel of the fuel cell stack, provided with fine apertures to penetrate coolant therethrough, and containing an ion resin filed therein; a checker disposed at the mesh tube body to be movable toward one portion and the other portion (e.g., to be movable toward each end of the mesh tube body) and having one end (e.g., a first end) exposed to the exterior of the mesh tube body and the other end (e.g., a second end) inserted into the mesh tube body, and an elastic member disposed between the second end of the checker and a first end of the mesh tube body to push the checker from one portion to the other portion (e.g., to push the checker forward and backward within the mesh tube body) by elasticity.

### BRIEF DESCRIPTION OF THE DRAWINGS

The above and other objects, features and advantages of the present disclosure will be more apparent from the following detailed description taken in conjunction with the accompanying drawings.

FIG. 1 is an exemplary left side view schematically showing an ion filter lifetime perception device for a fuel cell vehicle according to an exemplary embodiment of the present disclosure;

FIG. 2 is an exemplary use state view showing that a volume of an ion resin is reduced and accordingly, a checker moves in FIG. 1 according to an exemplary embodiment of the present disclosure;

FIG. 3 is an exemplary use state view schematically showing that the ion filter lifetime perception device for a fuel cell vehicle according to an exemplary embodiment of the present disclosure is installed in a cartridge of an ion filter; and

FIG. 4 is an exemplary view showing a acid cation exchange resin of an ion filter for a fuel cell vehicle according to an exemplary embodiment of the present disclosure.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, plug-in hybrid electric vehicles, hydrogen powered vehicles and other alternative fuel vehicles (e.g. fuels derived from resources other than petroleum). As referred to herein, a hybrid vehicle is a vehicle that has two or more sources of power, for example both gasoline-powered and electric-powered vehicles.

The terminology used herein is for the purpose of describing particular embodiments only and is not intended to be limiting of the disclosure. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present disclosure will be described in detail with reference to the accompanying drawings. However, the present disclosure will be not limited or restricted to exemplary embodiments below. Like reference numerals proposed in each drawing denote like components.

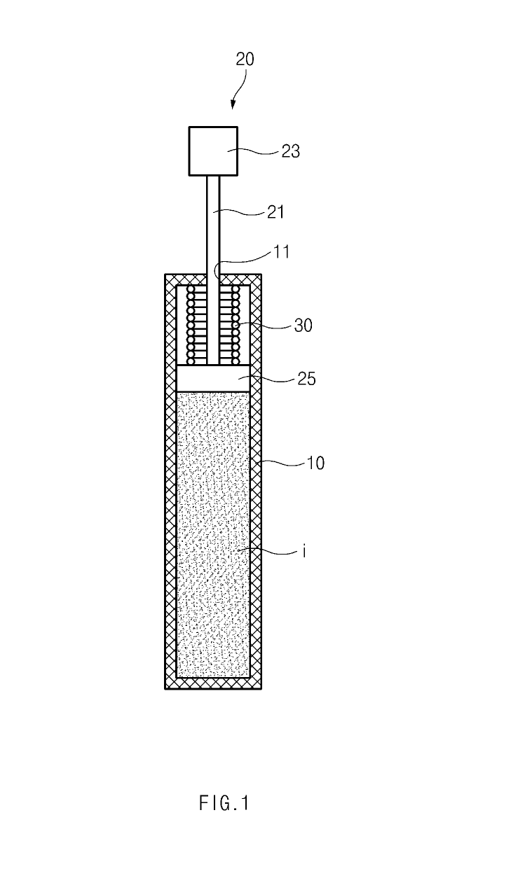

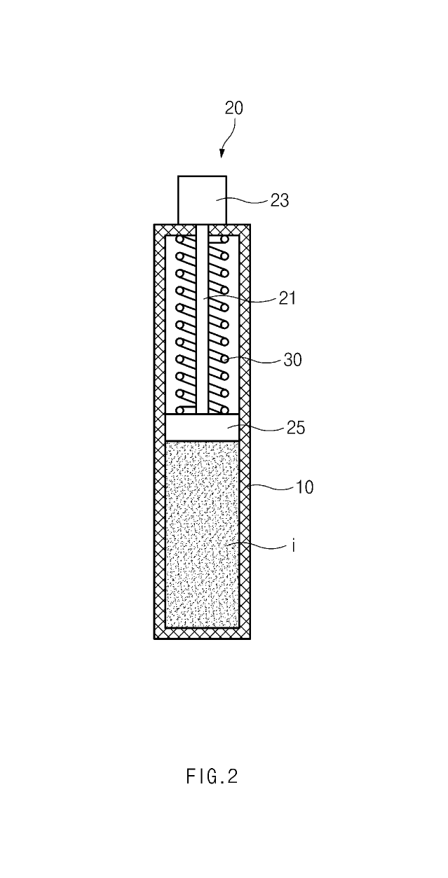

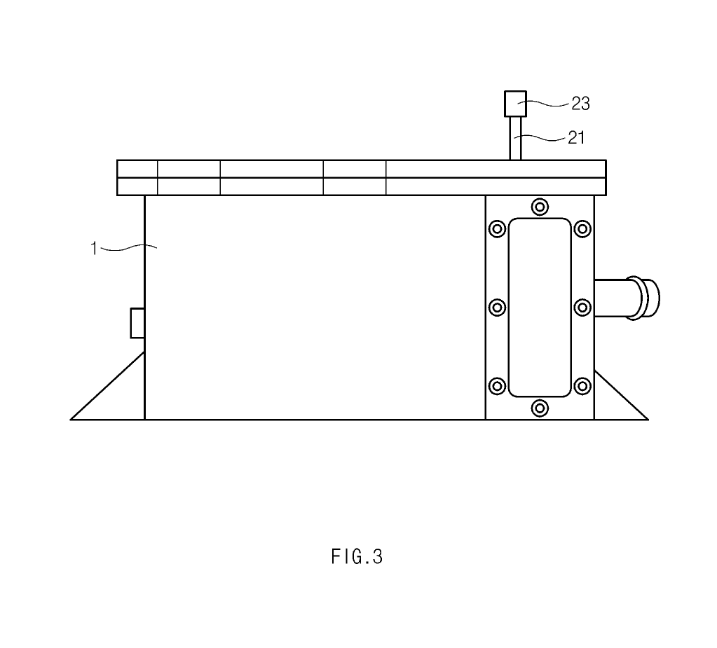

FIG. 1 is an exemplary left side view schematically showing an ion filter lifetime perception device for a fuel cell vehicle according to an exemplary embodiment of the present disclosure, FIG. 2 is an exemplary use state view showing that a volume of an ion resin is reduced and accordingly, a checker moves in FIG. 1, and FIG. 3 is an exemplary use state view schematically showing that the ionfilter lifetime perception device for a fuel cell vehicle according to an exemplary embodiment of the present disclosure is installed in a cartridge of an ion filter.

As shown in FIGS. 1 to 3, the ion filter lifetime perception device for a fuel cell vehicle according to an exemplary embodiment of the present disclosure may include a mesh tube body 10 mounted within a cartridge 1 of an ion filter, containing an ion resin (i) filled therein, and provided with fine apertures to penetrate coolant therethrough; a checker 20 disposed at one end (e.g., a first end) of the mesh tube body 10 to be movable toward one portion and the other portion (e.g., to be movable within the mesh tube body 10, along the length of) and having one end (e.g., a first end) exposed to the exterior of the mesh tube body 10 and the other end (e.g., a second end) inserted into the mesh tube body 10; and an elastic member 30 disposed between the second end of the checker 20 and the first end of the mesh tube body 10 to push the check 20 from along the mesh tube body 10 (e.g., from the first to the second end) by elasticity.

The arrow in FIG. 1 shows movement of the coolant acting in a fuel cell stack. In particular, the coolant may penetrate through the ion filter to be circulated and flow through the inner portion of the ion filter, particularly, the ion filter lifetime perception device for a fuel cell vehicle of the present disclosure mounted in the cartridge 1 installed in the ion filter. Therefore, the cartridge 1 and the ion filter lifetime perception device for a fuel cell vehicle of the present disclosure mounted in the cartridge 1 may be positioned on a channel of the coolant.

In addition, the mesh tube body 10 may be entirely or partially provided with a plurality of fine apertures to form a mesh net shaped tube body enabling the coolant to penetrate therethrough. That is, the mesh tube body 10 may be formed as a mesh net by a plurality of apertures. Further, an aperture 11 may be formed in a first end of the mesh tube body 10 to allow the checker 20 to move between the first and the second ends of the mesh tube body 10 when the checker 20 penetrates through the first end of the mesh tube body 10.

The checker 20 may include a bar shaped body 21 that penetrates through the aperture 11, a gauge member 23 disposed at a first end of the body 21 and having a circumference greater than that of the aperture 11, and a packing member 25 disposed at a second end of the body 21 to be air-tight between the checker 20 and the internal portion of the mesh tube body 10. The gauge member 23 may prevent the checker 20 from being completely input into the mesh tube body 10 by having a circumference greater than that of the aperture 11 while being exposed to the exterior of the cartridge 1 of the ion filter to allow a degree of movement of the checker 20 to be detected from the exterior (e.g., a person may visually detect the movement).

In addition, the packing member 25 may be formed to have a circumference greater than that of the body 21 to be air-tight between the circumference of the packing member 25 and the internal portion of the mesh tube body 10, to allow the packaging member 25 to prevent the ion resin (i) filled in the mesh tube body 10 from leaking between the circumference of the packing member 25 and the mesh tube body 10. Further, the checker 20 may more accurately correspond to a volume change in the ion resin (i) filled in the mesh tube body 10 to move by forming the circumference of the packing member 25 and the internal portion of the mesh tube body 10 to be air-tight.

The elastic member 30 may be a generally used spring such as a coil spring, a plate spring, a line spring, or the like. The second end of the elastic member 30 may be supported by the packing member 25, and a first end of the elastic member 30 may be supported by an inner surface of the first end of the mesh tube body, to cause the elastic member 30 to push the checker 20 from one end to the other end by compression elasticity.

Further, the ion resin (i) may be filled in the second end of the internal portion of the mesh tube body 10 based on the packing member 25 to provide a pressure that pushes the checker 20 toward the first end (e.g., from one end of the mesh tube body 10 to the other). When a volume of the ion resin (i) is reduced, the checker 20 may be moved from one end to the other end by compression elasticity of the elastic member 30 based on the volume reduction. In other words, when the volume of the ion resin (i) is reduced, the checker 20 may be moved from one end to the other end by elastic force of the elastic member 30 relative to the decrease in volume of the ion resin (i).

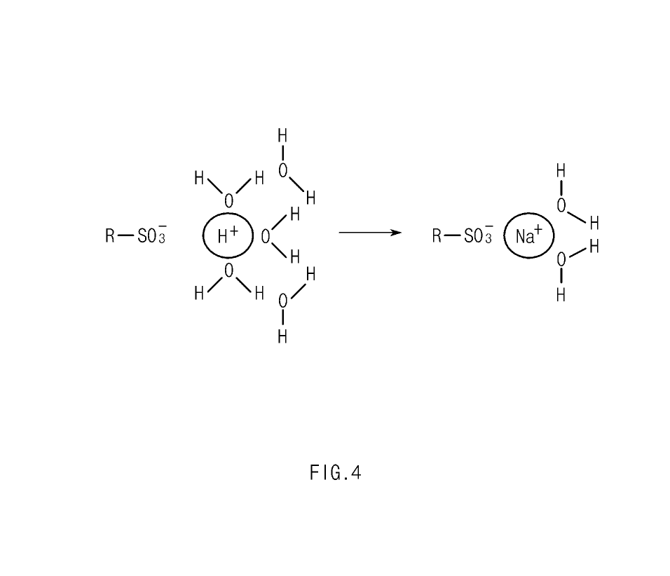

The principle of volume reduction of the ion resin of the ion filter according to the present disclosure is described with reference to FIG. 4. In particular, FIG. 4 is an exemplary view showing an acid cation exchange resin of an ion filter for a fuel cell vehicle according to an exemplary embodiment of the present disclosure. As shown in FIG. 4, in the acid cation exchange resin (SAC), ions are adsorbed, for example, as in the following Reaction Formula: R−SO₃H+Na⁺→R−SO₃Na+H⁺.

In addition, although not shown, in a base anion exchange resin (SBA), ions are adsorbed after filtering, for example, as in the following Reaction Formula: R−NOH+CI⁻→R−NCI+OH⁻. A volume of the acid cation exchange resin may be reduced by about 8% as described above, and a volume of the base anion exchange resin may be reduced by about 20%. Therefore, referring to FIG. 2, when the volume of the ion resin (i) is reduced, the checker 20 may move from one end to the other end of the mesh tube body 10, and thus, the gauge member 23 approaches to the mesh tube body 10, allowing for a replacement time of the cartridge to be determined.

Since the gauge member 23 should be installed to the cartridge 1 of the ion filter to be detected from the exterior (e.g., viewable from the exterior), during the installation of a cover (not shown) for protecting the gauge member 23 on the cartridge 1 of the ion filter, the gauge member 23 may be detected from the exterior by forming the cover using transparent plastic or glass, or the like. The ion filter lifetime perception device for a fuel cell vehicle according to an exemplary embodiment of the present disclosure configured as described above may thus economically reduce a manufacturing cost by removing an electric conductivity sensor. In addition, the need to implement an electronic control may be omitted thus reducing a defect generation rate.

Further, since wiring and electromagnetic wave test verification may be omitted, a manufacturing cost may be reduced. The ion filter lifetime perception device for a fuel cell vehicle according to an exemplary embodiment of the present disclosure configured as described above has a significantly simplified structure to be manufactured more easily, thus reducing the manufacturing costs.

In the ion filter lifetime perception device for a fuel cell vehicle according to an exemplary embodiment of the present disclosure configured as described above, the lifetime of the cartridge of the ion filter may be confirmed by a driver or in a repair shop in real time, thereby making it possible to improve maintainability of a vehicle. Since the filter lifetime perception device for a fuel cell vehicle according to an exemplary embodiment of the present disclosure configured as described above may be inserted into the cartridge of the ion filter, a separate installation space in the ion filter is not required.

Hereinabove, the ion filter lifetime perception device for a fuel cell vehicle according to the present disclosure is described with reference to the accompanying drawing, but the present disclosure is not limited to the above-mentioned exemplary embodiment and drawings but may be variously modified and changed within the following claims by those skilled in the art to which the present disclosure pertains.

What is claimed is:

1. An ion filter lifetime perception device for a fuel cell vehicle, comprising:
a mesh tube body mounted in an ion filter, containing an ion resin filed therein, and provided with fine apertures to penetrate coolant therethrough;
a checker disposed at the mesh tube body to be movable toward a first end and a second end of the mesh tube body and having a first end penetrating through the first end of the mesh tube body to be exposed to the exterior and a second end inserted into the mesh tube body, and
an elastic member disposed between the second end of the checker and the one end of the mesh tube body to push the check from the first end to the second end by elasticity.

2. The ion filter lifetime perception device for a fuel cell vehicle according to claim 1, wherein the mesh tube body further includes an aperture formed at a first end thereof to cause the checker to penetrate therethrough.

3. The ion filter lifetime perception device for a fuel cell vehicle according to claim 2, wherein the checker includes a gauge member having a circumference greater than that of the aperture at the first end thereof.

4. The ion filter lifetime perception device for a fuel cell vehicle according to claim 3, wherein the gauge member is exposed to the exterior of a cartridge of the ion filter.

5. The ion filter lifetime perception device for a fuel cell vehicle according to claim 3, wherein the gauge member is mounted in the ion filter to be covered by a transparent cover made of a transparent material, such that the gauge member is viewable from the exterior.

6. The ion filter lifetime perception device for a fuel cell vehicle according to claim 1, wherein the mesh tube body is entirely or partially provided with a plurality of fine apertures.

7. The ion filter lifetime perception device for a fuel cell vehicle according to claim 1, wherein the checker further includes a packing member formed at the second end thereof to allow an internal portion of a body part and a circumference of the checker to be air-tight.

8. The ion filter lifetime perception device for a fuel cell vehicle according to claim 7, wherein the second end of the elastic member is supported by the packing member and the first end of the elastic member is supported by the first end of the mesh tube body.

9. The ion filter lifetime perception device for a fuel cell vehicle according to claim 1, wherein the checker moves from the first end to the second end based on a volume reduction of the ion resin.

10. An ion filter lifetime perception device for a fuel cell vehicle installed in a fuel cell stack, the ion filter lifetime perception device for a fuel cell vehicle, comprising:
a mesh tube body mounted in an ion filter to be positioned on a coolant channel of the fuel cell stack, provided with fine apertures to penetrate coolant therethrough, and containing an ion resin filed therein;
a checker disposed at the mesh tube body to be movable toward a first end and a second end of the mesh tube body and having a first end exposed to the exterior of the mesh tube body and a second end inserted into the mesh tube body, and
an elastic member disposed between the second end of the checker and the first end of the mesh tube body to push the checker from the first end to the second end by elasticity.
